(19) United States
(12) Patent Application Publication
(10) Pub. No.: US 2014/0042753 A1
(43) Pub. Date: Feb. 13, 2014

(54) ENERGY STORAGE RESERVOIR

(71) Applicants: Mark Bahner, Durham, NC (US); Scott H. Goodwin, Hillsborogh, NC (US)

(72) Inventors: Mark Bahner, Durham, NC (US); Scott H. Goodwin, Hillsborogh, NC (US)

(73) Assignee: Research Triangle Institute, International, Research Triangle Park, NC (US)

(21) Appl. No.: 14/002,896

(22) PCT Filed: Mar. 2, 2012
(86) PCT No.: PCT/US2012/027361

§ 371 Date: Oct. 31, 2013

Related U.S. Application Data
(60) Provisional application No. 61/448,791, filed on Mar. 3, 2011.

(51) Int. Cl. F03B 13/06; F15B 1/10; H02K 7/18; F15B 1/02

(52) U.S. Cl. CPC F03B 13/06; F15B 1/024; F15B 1/106; H02K 7/18
USPC 290/1 R; 60/372

(57) ABSTRACT

An energy management system includes an energy storage reservoir and a fluid pump. The reservoir includes a fluid reservoir configured to contain varying quantities of a fluid and to isolate the fluid from the ambient. The fluid reservoir has a top surface, bottom surface, flexible member, and at least one opening for filling or emptying the reservoir. A pressing mass of solid material is positioned above the fluid reservoir with a weight sufficient to press the reservoir and empty the reservoir of fluid when the reservoir opening is open. The pressing mass is supported by the fluid reservoir when the reservoir contains fluid and is closed. The flexible member is disposed around the fluid reservoir to seal the fluid and to facilitate vertical motion of the pressing mass as the reservoir is filled and emptied. The pump supplies fluid to the fluid reservoir via the opening.

### RELATED APPLICATIONS

This application claims priority of U.S. Provisional Patent Application Ser. No. 61/448,791, filed on Mar. 3, 2011, titled ENERGY STORAGE RESERVOIR, which application is incorporated in its entirety by reference in this application.

### TECHNICAL FIELD

The present invention relates generally to energy management systems and methods of storing and otherwise managing energy. More particularly, the present invention relates to energy storage reservoirs used in conjunction with energy management systems.

### BACKGROUND

Economies around the world are increasingly focusing on the use of alternative energy sources; i.e., “green” energy sources. Some alternative energy sources are limited temporally and/or geographically. Temporally limited alternative energy sources may be described as intermittent energy sources. For example, the supply of solar energy is limited to daylight hours. As another example, the supply of wind energy varies with the local weather at the particular wind farm. Demand for energy, on the other hand, is more cyclical in nature and may generally be described as being based on the typical work schedule of the particular consumer base. Utility companies have an installed base of some generation facilities that produce power at a substantially constant rate; e.g., nuclear power plants. Utility companies also have some generation facilities that respond to the cyclical nature of energy demand, such as natural gas powered generators. To better utilize carbon-free energy sources, some means of energy storage may be used to store excess energy (i.e., energy supplied during times of low energy demand, or “off-peak” times) to be used to generate power for introduction to the power grid at a later time when there is higher demand (e.g., “on-peak” times).

One technique (known as “pumped-storage hydroelectricity” or “hydro energy storage”) that has been used to store energy is to have two water reservoirs at different elevations. When there is excess energy available, the excess energy is used to pump water from the lower reservoir to the upper reservoir (i.e., the reservoir that is at a higher elevation than the lower reservoir). When there is a need for the excess energy, water is released from the upper reservoir and flows through a turbine-generator to generate electrical power. After exiting the turbine-generator, the water flows to the lower reservoir. To increase energy efficiency, a large height difference between the lower reservoir and the upper reservoir is desirable. The desired large height difference between the lower reservoir and the upper reservoir limits the locations where such hydro energy storage facilities may be located.

Another technique (known as “compressed air energy storage”) that has been used to store excess energy from various sources involves the use of off-peak electrical power to compress air into a large storage vessel. When there is a need for the excess energy, the air is released from the storage vessel and is used to feed a generator device to generate electric power during on-peak times. Some compressed air energy storage systems may utilize empty salt domes or caverns as the compressed air storage vessel, which limits the locations where such systems can be located.

There is an ongoing need for economically feasible, efficient energy storage technologies that can balance the disparities between energy generation times and energy need cycles (i.e., “load balancing”), irrespective of whether the energy source is intermittently supplied or continuously supplied. There is also a need for energy storage reservoirs that may be sited in various locations.

### SUMMARY

To address the foregoing problems, in whole or in part, and/or other problems that may have been observed by persons skilled in the art, the present disclosure provides methods, processes, systems, apparatus, instruments, and/or devices, as described by way of example in implementations set forth below.

According to one implementation, an energy management system includes an energy storage reservoir and a fluid pump. The energy storage reservoir includes a fluid reservoir configured to contain varying quantities of a fluid and to isolate the fluid from the ambient environment. The fluid reservoir includes the top surface, the bottom surface, and a flexible member. The fluid reservoir includes at least one opening for filling or for emptying the fluid reservoir. A pressing mass of solid material is positioned above the fluid reservoir. The weight of the pressing mass is sufficient to press the fluid reservoir and empty the fluid reservoir of the fluid when fluid reservoir opening is open. The pressing mass is supported by the fluid reservoir when the fluid reservoir contains fluid and the fluid reservoir is closed. The flexible member is disposed around the fluid reservoir to seal the fluid and to facilitate vertical motion of the pressing mass as the fluid reservoir is filled and emptied. The fluid pump is configured to supply fluid to the fluid reservoir via the at least one opening.

According to another implementation, where the top surface of the fluid reservoir is formed on a first layer in contact with the bottom pressing mass surface; the bottom surface of the fluid reservoir is formed on a second layer having the opening for filling or emptying the fluid reservoir; and the flexible member includes a flexible sidewall affixed to the first rigid layer on one end of the flexible sidewalls, and to the second rigid layer on the other end of the flexible sidewalls to enclose the fluid in the fluid reservoir.

According to another implementation, the fluid reservoir of the energy management system includes a cavity formed by a rigid cavity sidewall wall of solid material surrounding a space in the cavity. The cavity has a cavity bottom surface. The pressing mass includes a pressing mass bottom surface and pressing mass walls extending upward from the pressing mass bottom surface. The pressing mass has a perimeter formed by the pressing mass walls that substantially conforms to the perimeter formed by the cavity sidewall of the cavity. The pressing mass has a size such that the pressing mass moves up and down inside the cavity. The flexible member is a flexible membrane extending from a first edge attached to the pressing mass wall and a second edge attached to the cavity sidewall to provide a substantial seal across the space between the pressing mass wall and the cavity sidewall. The top surface of the fluid reservoir is the pressing mass bottom surface. The bottom surface of the fluid reservoir is the cavity floor, and the at least one opening for filling or for emptying the fluid is formed in the cavity floor.

In some implementations, the energy management system may include a grid-connected generator in communication with the fluid reservoir. The generator device is configured for generating output power when the fluid is released from the fluid reservoir and into contact with the generator device.

In some implementations, the energy management system may include a fluid pump power supply that is generated from an intermittent energy source or other continuous energy sources.

According to another implementation, a method of managing energy is provided. Fluid is pumped into an opening of a fluid reservoir having a pressing mass of solid material positioned on top of the fluid reservoir. The pressing mass is lifted as the fluid fills the fluid reservoir, thus storing energy. The fluid flow into the fluid reservoir is stopped and the fluid is held in the fluid reservoir. The fluid reservoir is opened to release the fluid. The fluid is pushed out of the fluid reservoir by a downward force of the pressing mass to provide a flow of fluid for generating energy.

In some implementations, electrical power is generated by flowing the fluid from the energy storage reservoir to the grid-connected generator device.

In some implementations, the electrical power is generated during peak demand.

In some implementations, power is supplied to the fluid pump that is generated during off-peak demand.

Other devices, apparatus, systems, methods, features and advantages of the invention will be or will become apparent to one with skill in the art upon examination of the following figures and detailed description. It is intended that all such additional systems, methods, features and advantages be included within this description, be within the scope of the invention, and be protected by the accompanying claims.

### BRIEF DESCRIPTION OF THE DRAWINGS

The invention can be better understood by referring to the following figures. The components in the figures are not necessarily to scale, emphasis instead being placed upon illustrating the principles of the invention. In the figures, like reference numerals designate corresponding parts throughout the different views.

FIG. 1A is a cross-sectional elevation view of an example of an energy storage reservoir.

FIG. 1B is a cross-sectional elevation view of the energy storage reservoir in FIG. 1A with a platform under the pressing mass.

FIG. 1C is a cross-sectional elevation view of an energy storage reservoir using loose material as a pressing mass.

FIG. 2A is a cross-sectional elevation view of an example of an energy storage reservoir that includes stabilizing structure.

FIG. 2B is a cross-sectional elevation view of an example of an energy storage reservoir that includes another example of stabilizing structure.

FIG. 2C is a cross-sectional elevation view of an example of an energy storage reservoir that includes stabilizing structure.

FIGS. 3A, 3B, and 3C are cross-sectional elevation views of another example storage reservoir.

FIG. 4 is a schematic of an example of an energy management system.

FIG. 5 is a flow chart illustrating an example of a method for managing energy.

### DETAILED DESCRIPTION

Disclosed herein is an energy storage reservoir that may be used in conjunction with an energy management system. For example, the energy storage reservoir disclosed herein may be used to store energy from an intermittent energy source, such as an alternative energy source (e.g., wind or solar). As used herein, the term “intermittent energy source” is used to refer to any source of energy that is supplied on an intermittent and/or fluctuating basis. Often, but not always, a particular supply of intermittent energy may be limited by the time of day (e.g., solar energy) or the weather or geography (e.g., wind energy). When the energy to be stored in the energy storage reservoir is supplied by an intermittent energy source, the energy storage reservoir may be used to level the supply of energy to a grid-connected electrical power generator. For example, the energy storage reservoir may be used to absorb the energy load at times of high output and low energy demand, thus providing added peak capacity. In some implementations, the energy storage reservoir disclosed herein may be used to store excess energy from a continuous energy source. As used herein, the term “continuous energy source” is used to refer to any source of energy that may be supplied on a substantially continuous and/or non-fluctuating basis (e.g., nuclear energy, energy released from the burning of coal, etc.). As with intermittent energy sources, when the energy to be stored in the energy storage reservoir is supplied by a continuous energy source, the energy storage reservoir may be used to: (1) store the energy supplied during off-peak times; and (2) release the energy during on-peak times. This process of storing energy during off-peak times and releasing energy during on-peak times may be referred to herein as “load balancing.”

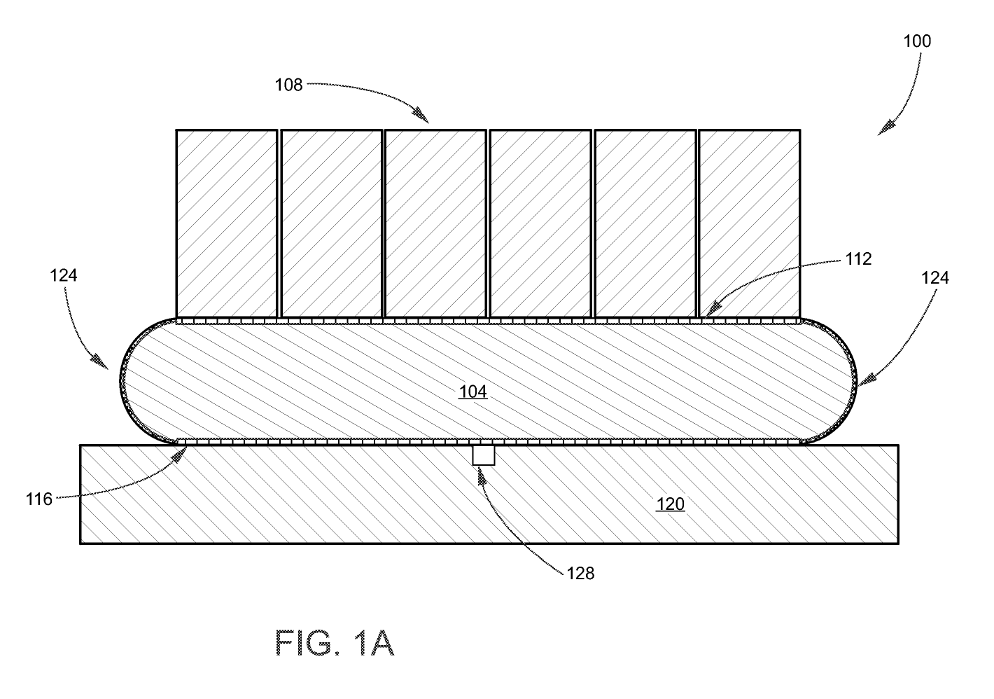

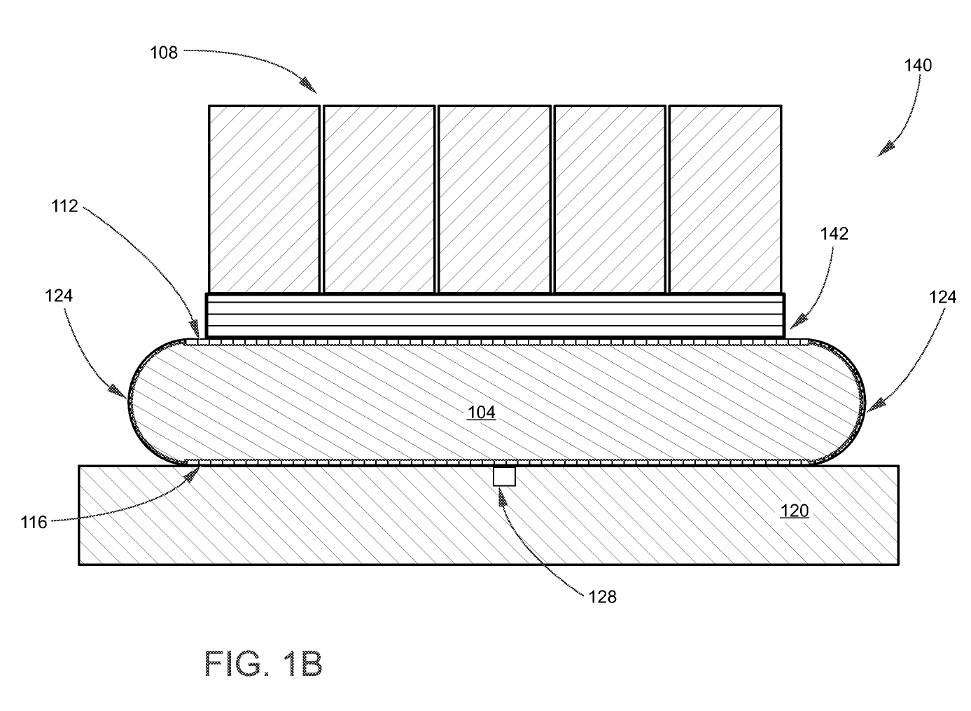

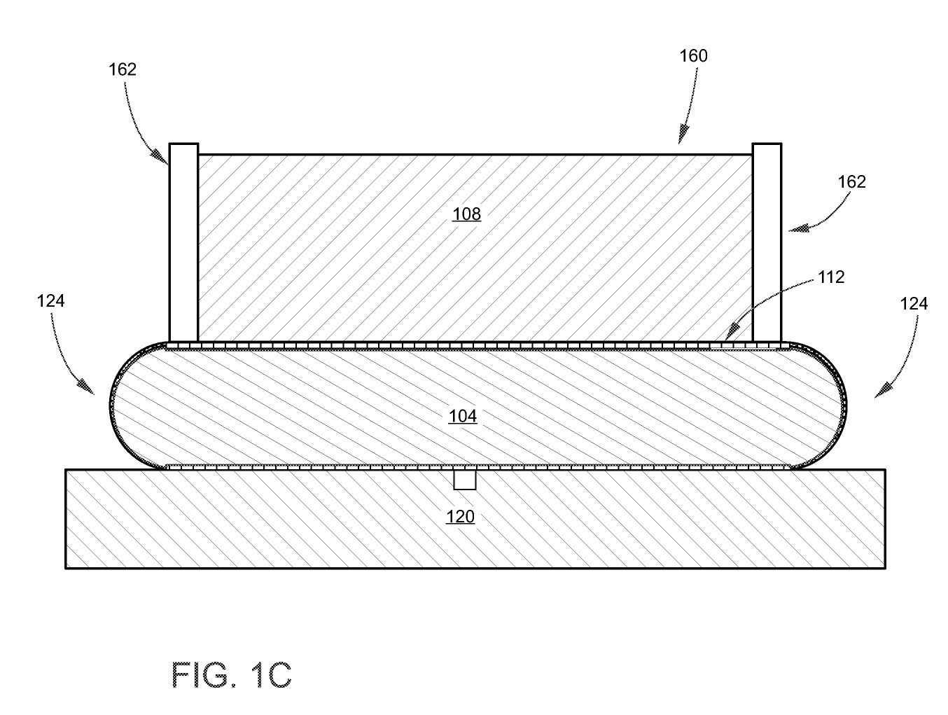

In examples of implementations described below with reference to FIGS. 1A-5, the energy storage reservoir includes a pressing mass disposed above a fluid reservoir. The fluid reservoir has a top surface, a bottom surface and a flexible member. The fluid reservoir may contain varying quantities of a fluid, and is configured to isolate the fluid from the ambient environment. At least one opening is included for filling or for emptying the fluid reservoir.

The pressing mass is made of solid material having a weight sufficient to press the fluid in the fluid reservoir and empty the fluid reservoir of the fluid when the fluid reservoir opening is open. The pressing mass is supported by the fluid in the fluid reservoir when the fluid reservoir contains fluid and the fluid reservoir is closed. The flexible member of the fluid reservoir is disposed around the fluid reservoir to seal the fluid and to facilitate vertical motion of the pressing mass as the fluid reservoir is filled and emptied.

FIG. 1A is a cross-sectional elevation view of an example of an energy storage reservoir (or “energy storage system” or “energy storage apparatus”) 100. The energy storage reservoir 100 illustrated in FIG. 1A may be used to store energy from any energy source. The energy storage reservoir 100 generally includes a fluid reservoir 104 and a pressing mass 108 of solid material supported by a top surface 112 of the fluid reservoir 104. As shown in FIG. 1A, a bottom surface 116 of the fluid reservoir 104 may be supported by the ground 120. The ground 120 may be substantially flat to aid in stabilizing the energy storage reservoir 100. In some implementations, the bottom surface 116 of the fluid reservoir 104 may be directly in contact with the ground 120. In some implementations, a substantially flat, rigid platform (made out of concrete or steel, for example) may be disposed between the ground 120 and the bottom surface 116 of the fluid reservoir 104.

The top surface 112 and the bottom surface 116 of the fluid reservoir 104 are formed as supportive, substantially inelastic layers separated by opposing flexible sidewalls 125. The opposing flexible sidewalls 124 form the flexible member for facilitating the vertical motion of the pressing mass 108. It is noted that in this description, the opposing flexible sidewalls 124 are referenced in plural form to identify the opposing sidewalls illustrated in the cross-sectional view of FIGS. 1A-1C. In an example implementation, the fluid reservoir 104 includes only one sidewall surrounding the space within the fluid reservoir 104. The fluid reservoir 104 generally includes a fluid opening 128 for receiving a fluid (such as water or compressed air) or for dispensing the fluid from the fluid reservoir 104. As shown in FIG. 1A, in some implementations the fluid opening 128 may be located at the bottom surface 116 of the fluid reservoir 104. In general, the fluid opening 128 may be positioned at any suitable location, as long as the fluid opening 128 is in fluid communication with the fluid reservoir 104. Implementations are not limited to a single opening for receiving and dispensing fluid from the fluid reservoir 104. The fluid reservoir 104 may include a multiple fluid inlet/outlet ports, or the fluid reservoir 104 may include one or more inlet ports, and one more outlet ports.

The flexible sidewalls 124 enable the volume within the fluid reservoir 104 to expand or conform in shape to accommodate varying quantities of fluid (e.g., water or compressed air) as the fluid reservoir 104 is filled. The fluid reservoir 104 is sealed to isolate the fluid within the fluid reservoir 104 from the ambient environment. The flexible sidewall 124 may be made of any suitable material that is capable of withstanding substantial pressure as a result of the pressing mass 108 supported by the top surface 112 of the fluid reservoir 104. In some implementations, the top surface 112, the bottom surface 116, and the opposing sidewalls 124 may be made of the same material and configured to form an enclosure for the fluid.

In some implementations, the top surface 112 and the bottom surface 116 may be made of a material that is different than the material of the opposing sidewalls 124. It is noted that FIG. 1A depicts the top surface 112 and the bottom surface 116 with a different pattern than the flexible sidewalls 124 to indicate that the surfaces 112, 116 are of a different material than the sidewalls 124. The top surface 112 and/or the bottom surface 116 may be formed on a layer of concrete, metal (including steel, for example), or any other suitable strong, and substantially inelastic material. The opposing sidewalls 124 may be made of any suitable flexible material. The flexible material of the opposing sidewalls 124 may be material that is resistant to UV degradation, strong, durable, and have a sufficient elastic modulus. In some implementations, the opposing sidewalls 124 may be made from a polymeric material such as chlorosulfonated polyethylene (e.g., Hypalon®), reinforced neoprene (such as Kevlar®-reinforced neoprene), or the like. The flexible sidewall 124 may be attached to the layers forming the top surface 112 and the bottom surface 116 using any suitable attachment mechanism. In one example, the layers may be made of concrete, and the flexible sidewall 124 may be inserted into the edges of the layers before the concrete has set so that the flexible sidewall 124 is fixedly attached when the concrete has completely set. Other attachment mechanisms such as bolts may also be used in conjunction with sealing techniques such as a cover over any seam between the layers and the sidewall. Combinations of attachment methods may be used to ensure the attachment. To add strength to the opposing sidewalls 124, a steel or other high strength mesh material may be disposed on or at the exterior surfaces of the opposing sidewalls 124. The fluid reservoir 104 may be any desired shape, such as cylindrical, elliptical, polygonal, etc., so long as the top surface 112 is able to support the pressing mass 108.

The pressing mass 108 may be formed as a single mass of solid material, or as shown in FIG. 1A, a plurality of masses of material distributed over the top surface 112 of the fluid reservoir 104. The pressing mass 108 may be formed with stone, concrete, rocks, metal, dirt, sand, or any other suitable weight bearing material. In some implementations, the pressing mass 108 may be directly disposed on the top surface 112 of the fluid reservoir 104. In other implementations, a solid, rigid, substantially flat platform may be disposed between the top surface 112 of the fluid reservoir 104 and the pressing mass 108. FIG. 1B shows an example of an energy storage reservoir 140 having a rigid platform 142 disposed between the top surface 112 of the fluid reservoir 104 and the pressing mass 108. The rigid platform 142 may be made of concrete, steel, or any other suitable material. The rigid platform 142 may aid in maintaining the stability of the pressing mass 108 and may prevent the pressing mass 108 from compromising the sealed state of the fluid reservoir 104.

The solid material of the pressing mass 108 may be selected from materials that are in the vicinity of the energy storage reservoir 100. To the extent such material comprises loose material, structure may be incorporated for retaining the material as the pressing mass. FIG. 1C illustrates an example of an energy storage reservoir 160 that uses a containment structure 162 filled with loose material. The containment structure 162 in FIG. 1C is a wall of sufficient strength and volume to retain the loose material that may be used in the pressing mass 108. The containment structure 162 in FIG. 1C is constructed about the perimeter of the top surface 112 of the fluid reservoir 104 functioning effectively as a bowl for the loose material. The containment structure 162 may extend vertically to a selected height sufficient to contain the loose material of the pressing mass 108. The containment structure 162 may also be constructed on top of a platform, such as the platform 142 in FIG. 1B.

The material used in the pressing mass 108 may be any suitable material, although some areas may provide a ready source of material. For example, the energy storage reservoir 100 may be constructed near a rock quarry, and the pressing mass 108 may include rock that is quarried from the local rock quarry. As another example, the pressing mass 108 may include mine tailings from a local mine. Other non-limiting examples of suitable solid material for the pressing mass 108 for use in conjunction with the energy storage reservoir 100 include sand, dirt, landfill waste, industrial waste (e.g., slag) and/or any other solid material for exerting substantial force on the top surface 112, thus pressurizing the fluid within the fluid reservoir 104.

The energy storage reservoir 100 may be used to store energy from any source for use at a later time. For example, a fluid pump (not shown), such as an air compressor (in implementations in which the fluid is compressed air) or a water pump (in implementations in which the fluid is water) may be in communication with the fluid reservoir 104 (i.e., via the fluid opening 128 used as an inlet port). The fluid reservoir 104 may initially be empty, or at least substantially empty with the opposing flexible sidewalls 124 rolled up to form a loop when viewing a cross-section of the fluid reservoir 104. As fluid (e.g., compressed air or water) is pumped by the fluid pump into the fluid reservoir 104, the opposing flexible sidewalls 124 unroll to accommodate the change in volume within the fluid reservoir 104. The opposing flexible sidewalls 124 may unroll to approach more vertical sidewalls to form more of an arc than the full loop when the fluid reservoir 104 is empty. As the fluid reservoir 104 fills with fluid, the pressing mass 108 is lifted vertically, and gravitational potential energy, PE_{g}, is stored according to the following formula:

PE_{g}=mgh

where m is the mass, g is the gravitational constant, and h is the height. Thus, the amount of gravitational potential energy stored in the energy storage reservoir 100 is proportional to the pressing mass 108 supported by the top surface 112 of the fluid reservoir 104. The amount of gravitational potential energy stored in the energy storage reservoir 100 is also proportional to the maximum height of the fluid reservoir 104. The maximum height of the fluid reservoir 104 may generally be considered to be the maximum height (measured from the ground 120 when the ground 120 supports the bottom surface 116 of the fluid reservoir 104) to which the top surface 112 of the fluid reservoir 104 may rise without mechanical failure (e.g., bursting) of the fluid reservoir 104.

The energy storage reservoir 100 provides specific advantages over traditional energy storage reservoirs. For example, in implementations in which the fluid is compressed air, the pressing mass 108 supported by the top surface 112 of the fluid reservoir 104 provides a more constant pressure within the fluid reservoir 104, which allows for design optimization of the air compressor (that supplies compressed air to the fluid reservoir 104) for added efficiency. Compressed air energy storage systems based on fixed structures such as caverns have variable pressure as the systems absorb or release energy. In implementations in which the fluid is water and the solid material of the pressing mass 108 is rock having a density of approximately three times greater than the density of water, the height of the mass of rock may be approximately one-third of the height difference between two water reservoirs in a standard hydro energy storage system for the same amount of stored potential energy (not taking into account the additional potential energy that is stored as a result of the height of the water in the fluid reservoir 104, the height being measured from the bottom surface 116 of the fluid reservoir 104 to the top surface 112 of the fluid reservoir 104). In other words, to achieve the same amount of stored energy as a standard hydro energy storage system, the energy storage reservoir 100 according to the present implementation requires a height of rock that is smaller than the height difference between two water reservoirs in the standard hydro energy storage system.

In implementations in which the fluid is water, the water may be pumped from a body of water (e.g., a pond, lake, lagoon, river, etc.) by the fluid pump. Although not required, placing the energy storage reservoir 100 on a local high ground 120 with respect to the body of water increases the stored potential energy associated with the pumped water held in the fluid reservoir 104. In some implementations, the body of water may be strategically located adjacent the energy storage reservoir 100, such that if the fluid reservoir 104 experiences mechanical failure, the water stored in the fluid reservoir 104 may flow into the body of water. In some implementations, a levee (or dam) may be constructed about the energy storage reservoir 100 to contain the pumped water (and reduce the likelihood of flooding) if the fluid reservoir 104 experiences mechanical failure. In some implementations, the levee may be constructed from a supply of rock that is used as the solid material of the pressing mass 108 supported by the top surface 112 of the fluid reservoir 104. For example, if the energy storage reservoir 100 is sited near a rock quarry, rock supplied from the rock quarry may be used as the solid material of the pressing mass 108 as well as material for construction of a levee about the energy storage reservoir 100.

As shown in FIG. 1A, the flexible sidewalls 124 may be curved. The curved sidewalls 124 may provide lateral stability to the pressing mass 108. For example, if the pressing mass 108 attempts to shift laterally (i.e., side-to-side), there will be a reduction in the volume available to the fluid on the side to which the pressing mass 108 attempts to shift, which would cause the pressing mass 108 to move up vertically to maintain the volume that is available for the pumped fluid within the fluid reservoir 104. As this is not the lowest potential energy for the energy storage reservoir 100, the curved flexible sidewalls 124 may facilitate “self-stabilization” of the pressing mass 108 by preventing lateral shifting.

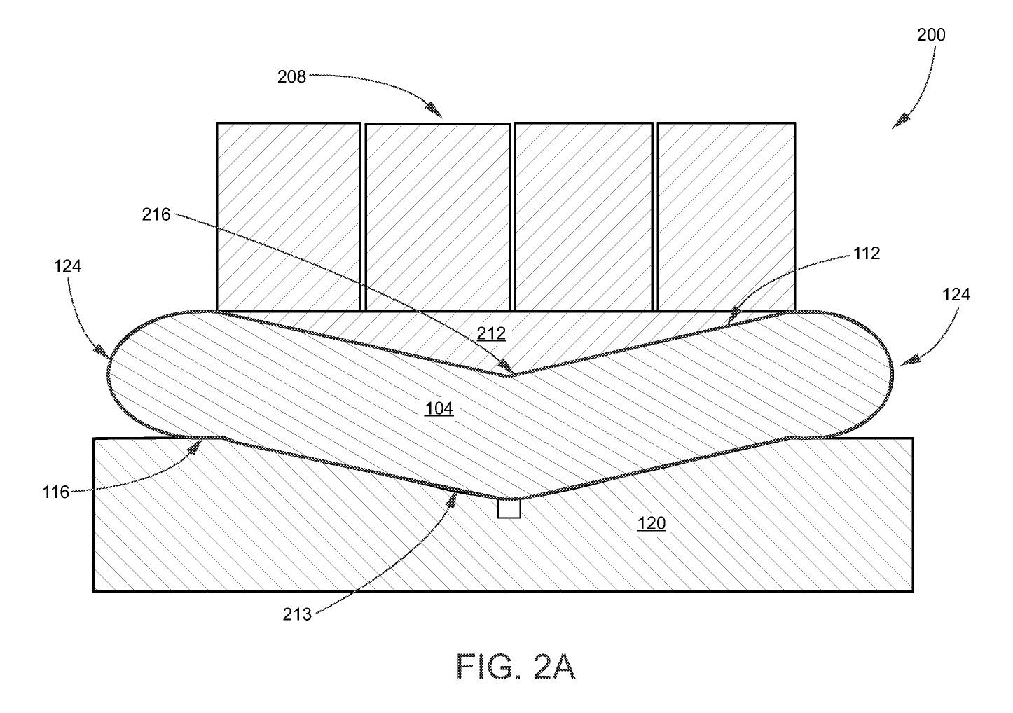

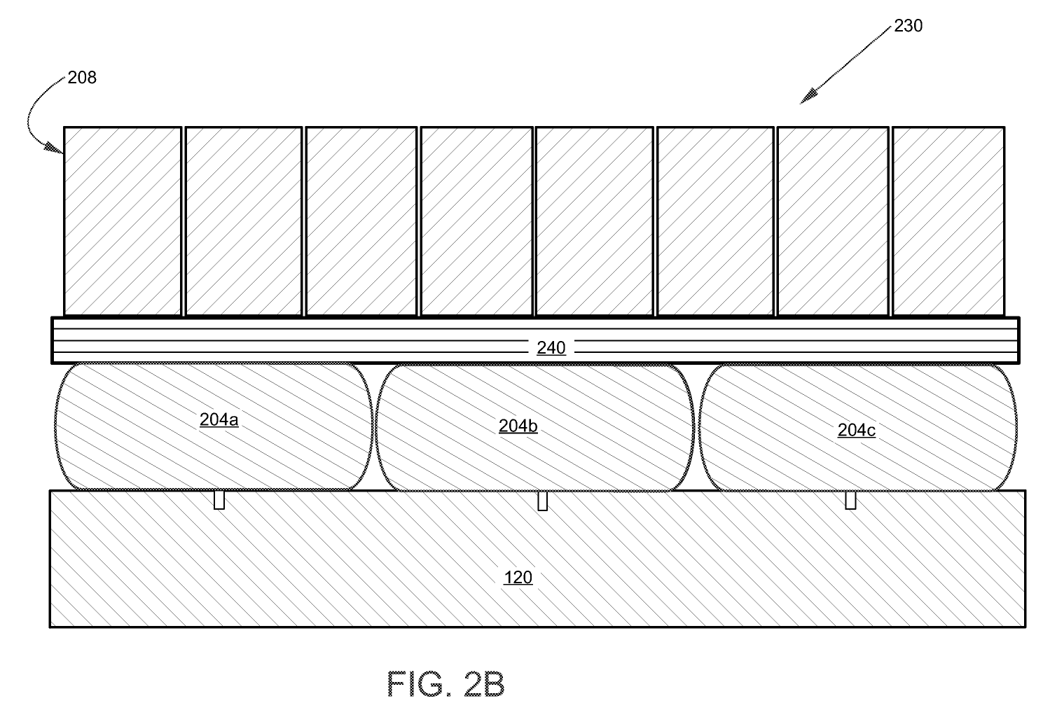

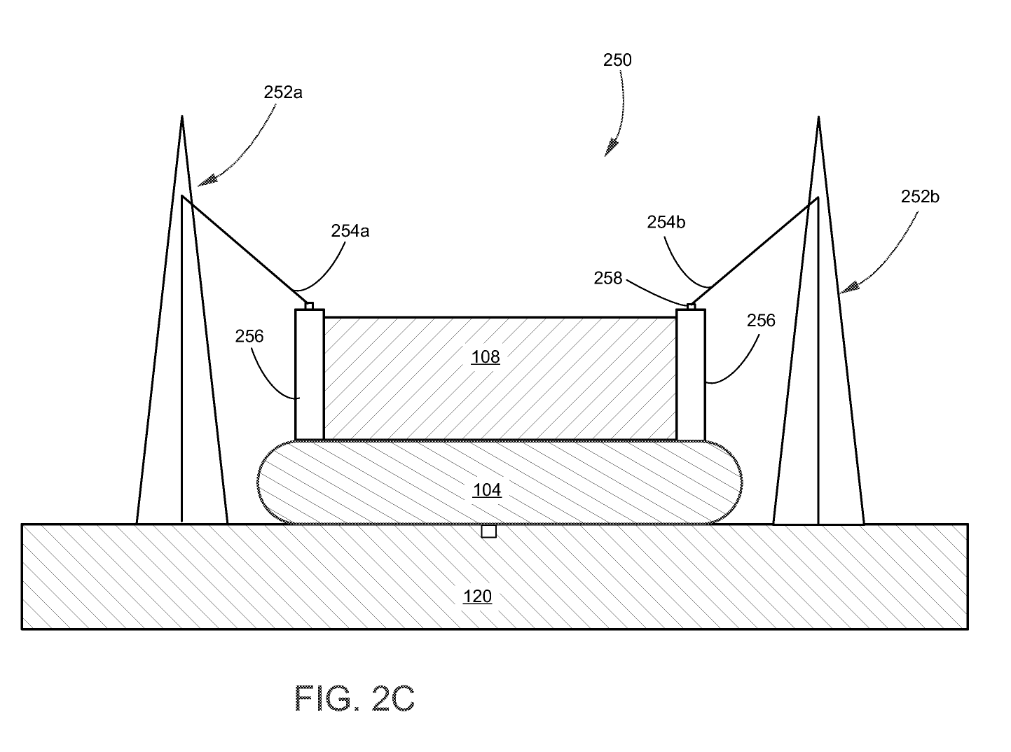

The energy storage reservoir 100 may include structure for stabilizing the pressing mass 108; i.e., to keep the pressing mass 108 from moving laterally and/or to keep the pressing mass 108 from tilting. FIGS. 2A-2C illustrate examples of ways to stabilize the pressing mass. It is noted that in the examples shown in FIGS. 2A-2C, the fluid reservoir is shown schematically, and may be implemented as a single material bag-like structure, or as a fluid reservoir having top and bottom surfaces of materials that are substantially inflexible, and sidewalls of another material that is flexible.

FIG. 2A shows one example implementation in which stabilizing structure is added to an energy storage reservoir 200. As illustrated in FIG. 2A, the pressing mass 208 may be formed to have a tapered bottom 212, which is illustrated in FIG. 2A as a V-shaped cross section representing a conical shape. The tapered bottom 212 may have any suitable shape in which the tapered bottom 212 of the pressing mass 208 tapers in toward a middle section 216 of the fluid reservoir 104. The ground 120 may also have a matching ground taper 213 to allow the pressing mass 108 to more completely empty the fluid reservoir 104. The tapered bottom 212 stabilizes the pressing mass 208 when the pressing mass 208 begins to tilt to one side, by causing a distribution of forces that provide an increased vertical lifting force to the side of the pressing mass 208 that is tilting.

In some implementations, the pressing mass 208 may be a mass of rock, and the tapered bottom 212 of the mass of rock may be formed into a conical shape during the quarrying process. In some implementations, the tapered bottom 212 may be formed using a substantially rigid platform made of concrete or any other suitable material and disposed between the top surface 112 of the fluid reservoir 104 and the pressing mass 208. The substantially rigid platform may include a bottom surface in contact with the top surface 112 of the fluid reservoir 104, and the surface of the tapered bottom 212 of the substantially rigid platform may have a substantially V-shaped cross-section. The ground 120 may be excavated so as to have the matching taper 213. A cavity in the ground 120 may also be filled with concrete using a mold in the shape of the matching taper 213. The matching taper 213 may be formed using any suitable method that provides a substantial fit with the tapered bottom 212 of the pressing mass 208.

FIG. 2B illustrates another example of an energy storage reservoir 230 that uses stabilizing structure for the pressing mass 108. The energy storage reservoir 230 includes multiple fluid reservoirs 204a, 204b, 204c positioned adjacent one another to form a collection of fluid reservoirs 204. Any number of fluid reservoirs 204 may be utilized in the collection and the fluid reservoirs 204 in the collection may be spatially arranged in any suitable manner. Each fluid reservoir 204a, 204b, 204c in the collection may be configured substantially the same as the fluid reservoir 104 described above with reference to FIG. 1A. The respective top surfaces may support the pressing mass 108 directly similar to the example shown in FIG. 1A. For example, the top surface of each fluid reservoir 204a, 204b, 204c in the collection may be utilized to support a single, rigid mass of solid material, such as rock, that forms the pressing mass 108. In the example illustrated in FIG. 2B, a flat, rigid platform 240 made of concrete, for example, may optionally be disposed between the respective top surfaces of the fluid reservoirs 204 and the pressing mass 108. Fluid may be selectively supplied by the fluid pump to any of the respective fluid reservoirs 204 to aid in providing lateral and/or tilt stability to the pressing mass 108; e.g., to counteract any shifts in the mass of solid material by supplying more fluid to the respective fluid reservoir that is supporting a lower side of the pressing mass 108.

FIG. 2C illustrates another example of an energy storage reservoir 250 that uses stabilizing structure for the pressing mass 108. The energy storage reservoir 250 uses towers 252a, 252b positioned near the fluid reservoir 104. The towers 252a, 252b include corresponding cables 254a, 254b that may be used to connect each tower 252a, 252b to the pressing mass 108. The cables may be adjusted in length to aid in stabilizing the pressing mass 108. For example, a pulley system may be operated to adjust the length of the cables 254a, 254b to keep the pressing mass 108 stabilized during the filling or emptying of the fluid reservoir 104.

The pressing mass 108 in the example shown in FIG. 2C includes loose material contained in a retaining wall 256. The cables 254a, 254b connect to the pressing mass 108 at the retaining wall 256 using a suitable cable connector 258, such as an anchored hook, an anchor eye bolt, or any other similar fastener. Only two towers 252a, 252b are shown in FIG. 2C, however, any number of towers 252 may be positioned around the energy storage reservoir 250 to provide the desired stability. In another implementation, other types of pressing masses 108 may be implemented, such as multiple masses of rocks or stones with a retaining wall provided for purposes of providing a connection for the cables 254a, 254b. Connections to the cables 254a, 254b may also be accomplished using a platform such as the platform 142 in FIG. 1B. The cable connectors 258 may be mounted on the platform so that the cables 254a, 254b may extend out towards the towers 252a, 252b.

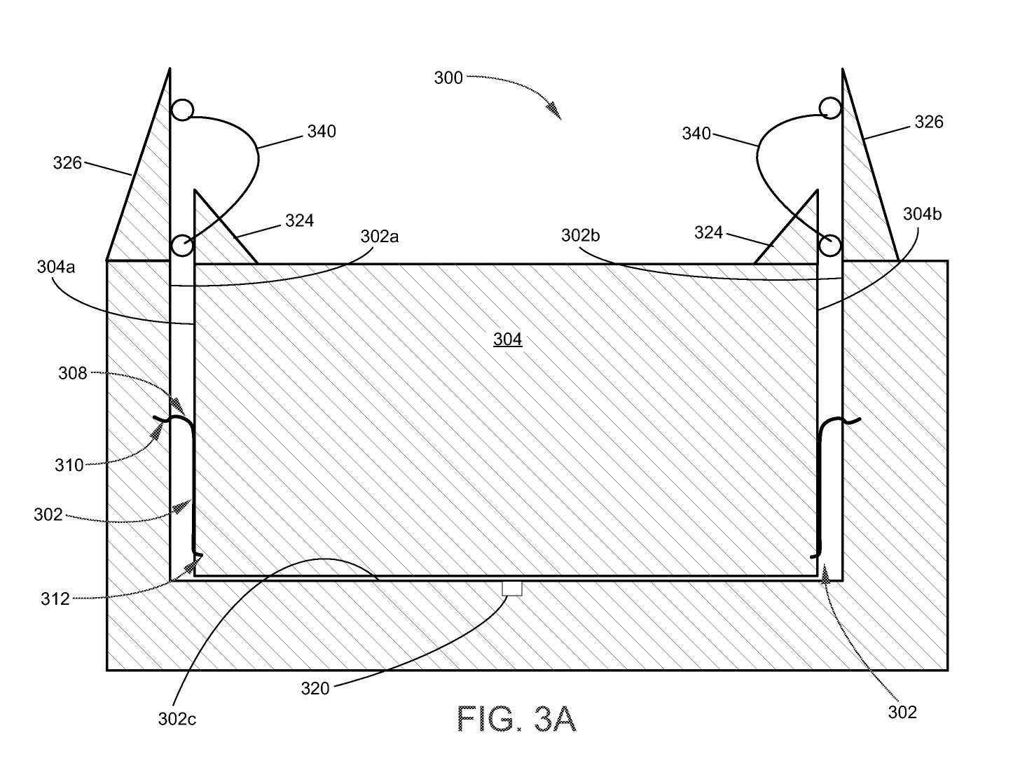

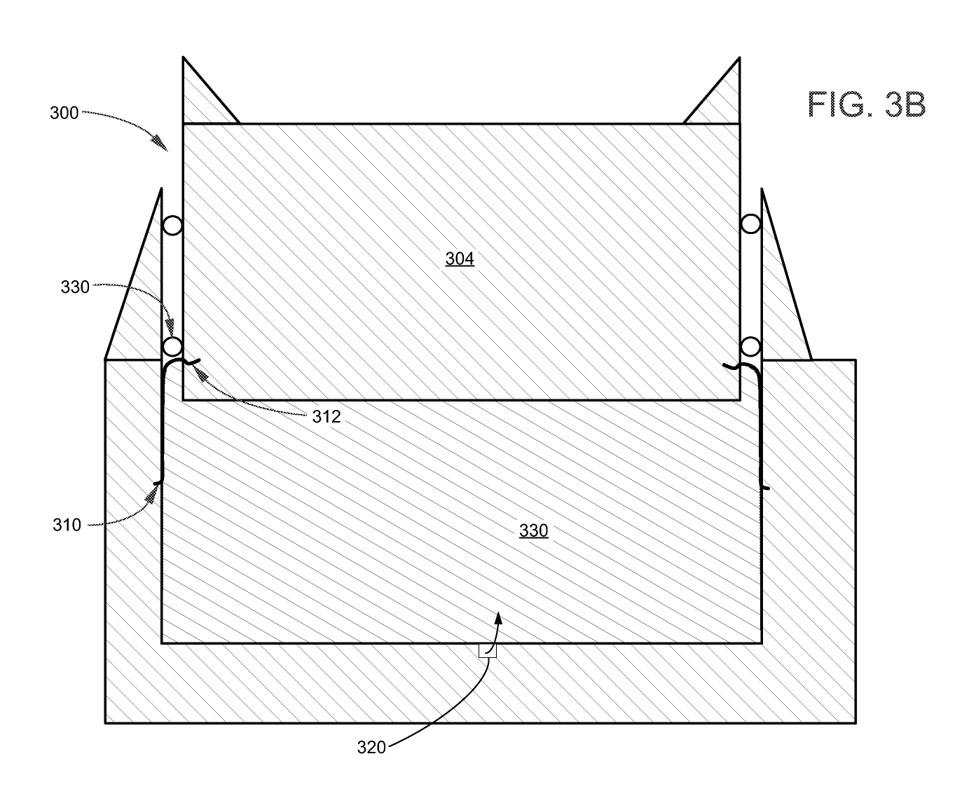

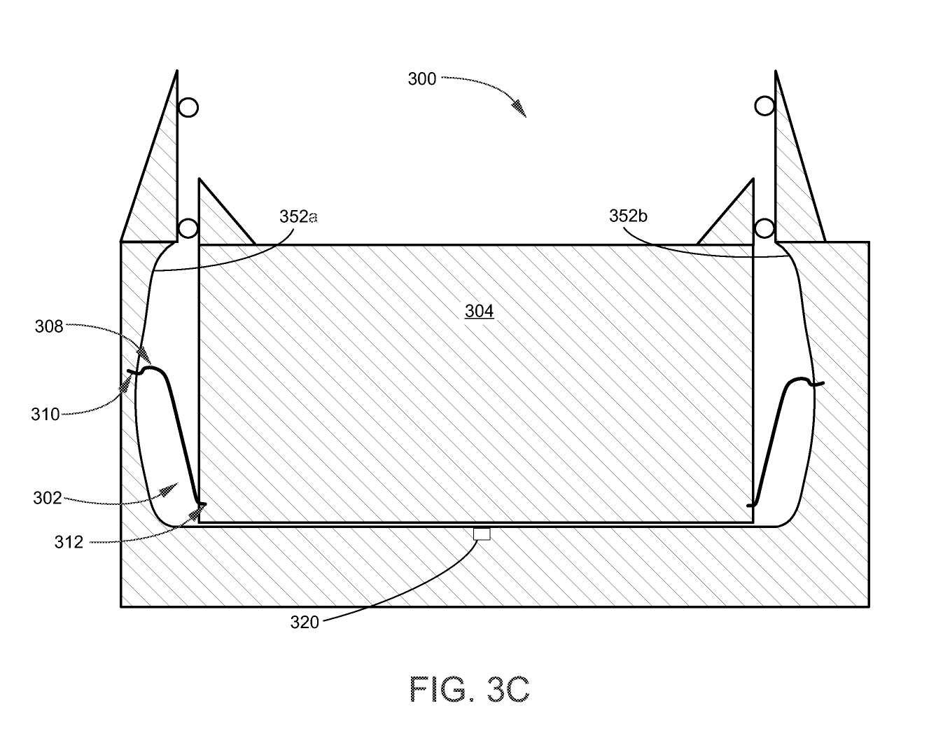

FIGS. 3A and 3B are cross-sectional views of another example of an energy storage reservoir 300. The energy storage reservoir 300 in FIGS. 3A and 3B includes a cavity 302 formed by opposing cavity sidewalls 302a, 302b, and a cavity floor 302c. The energy storage reservoir 300 also includes a pressing mass 304 positioned in the cavity 302. A flexible membrane 308 attaches to the pressing mass 304 and to the cavity 302 to form a seal for a fluid reservoir formed by the bottom surface of the pressing mass 304, the cavity sidewalls 302a, b, and the cavity floor 302c. The top surface of the fluid reservoir formed as shown in FIGS. 3A and 3B is the bottom surface of the pressing mass 304 and the bottom surface of the fluid reservoir is the cavity floor 302c. The flexible membrane 308 is the flexible member that facilitates the vertical motion of the pressing mass 304 as the fluid reservoir is filled and emptied. FIG. 3A shows the energy storage reservoir 300 in an empty state in which the energy storage reservoir 300 is empty of an energy medium. FIG. 3B shows the energy storage reservoir 300 in a non-empty state in which the energy storage reservoir 300 contains a selected fluid 330.

The cavity sidewalls 302a, 302b may be oriented substantially vertically relative to the earth's surface as shown in FIGS. 3A and 3B. The cavity sidewalls 302a, 302b may also have a concave form as illustrated by concave sidewalls 352a, 352b in FIG. 3C. The cavity sidewalls may also be straight, but slanted out other than vertical. It is noted that this description refers to the opposing cavity sidewalls 302a, 302b in the plural form to address the opposing cavity sidewalls 302a, 302b illustrated in the cross-sectional views in FIGS. 3A-3C. In an example implementation, the cavity 302 is formed by one cavity sidewall surrounding the space in the cavity 302. The cavity 302 may be any suitable shape from an overhead view (not shown). For example, the cavity sidewalls 302a, 302b may form a circle, a rectangle in segments of wall from overhead, or any other suitable shape when viewed from overhead. The cavity 302 may be a recess formed in the ground with walls of rock or other suitable, natural, and substantially non-porous material, or sufficiently non-porous to contain the desired fluid to be stored for a desired minimum length of time. The cavity 302 may also be a recess formed in the ground and lined with concrete, metal, plastic, or other suitable material that is sufficiently non-porous to contain the desired fluid to be stored for a desired minimum length of time. The cavity 302 may also be the hollow of a container-like structure formed to be set on, or partially in, the ground. The container-like structure may be made of any suitable material including concrete, metal, plastic, or other similar materials.

The energy storage reservoir 300 includes a pressing mass 304 having a size and shape that allows for the pressing mass 304 to move up and down in the cavity 302 with a weight sufficient to pressurize medium fluid distributed in the cavity 302 and beneath the pressing mass 304. The height of the pressing mass 304 may be selected so as to provide sufficient downward pressure on the fluid medium, and as such, the height may be lower, higher, or the same as the depth of the fluid filled cavity 302. For a fluid medium, such as water, for example, the pressing mass 304 may be made of rock, concrete, or any material sufficient to pressurize the fluid medium. The pressing mass 304 may be a container made of metal, rock, concrete or other suitable material, filled with the weight bearing material. The pressing mass 304 may be shaped to conform to the shape of the cavity 304 with pressing mass walls 304a, 304b formed opposite corresponding walls 302a, 302b of the cavity 302. The size of the pressing mass 304 may be smaller than the cavity 302 such that a space is provided between the opposing pressing mass walls 304a, 304b and cavity sidewalls 302a, 303b.

The cavity 302 may include at least one fluid opening 320 through which the fluid 330 may be added into the cavity 302, and through which the fluid 330 is permitted to escape the cavity 302 under the pressure provided by the pressing mass 304. An opening may be used as an inlet port for adding fluid into the cavity 302 and a separate opening may be used as an outlet port for allowing fluid to escape the cavity 302 in alternative implementations. Multiple inlet ports dedicated to the task of adding fluid, and multiple outlet ports dedicated to the task of allowing fluid to escape may also be implemented.

A flexible membrane 308 may be provided between the pressing mass 304 and the cavity sidewalls 302a, 302b to contain the fluid 330 as it is added to, and contained in, the cavity 302. The space between the cavity sidewalls 302a, 302b and the opposing pressing mass walls 304a, 304b is of a size sufficient to enable movement of the pressing mass 302 upward from the cavity 302 as the fluid 330 fills the cavity 302 underneath the pressing mass 304. The flexible membrane 308 may be a somewhat elastic film having edges that are fixedly secured in the cavity sidewalls 302a, 302b and in the pressing mass walls 304a, 304b. The material of the flexible membrane 308 may be resistant to UV degradation, strong, durable, and have a sufficient elastic modulus. The flexible membrane 308 should not be so elastic that the tensile strength of the membrane 308 is insufficient to contain the fluid. Examples of materials that may be used for the flexible membrane 308 include a polymeric material such as chlorosulfonated polyethylene (e.g., Hypalon®), reinforced neoprene (such as Kevlar®-reinforced neoprene), or the like. To add strength to the flexible membrane 308, a steel or other high strength mesh material may be disposed on or at one of the surfaces of the flexible membrane 308. The flexible membrane 308 may be fixed to the cavity sidewalls 302a, 302b and pressing mass walls 304a, 304b with a seal sufficient to prevent the escape of the fluid medium in the cavity 302.

The flexible membrane 308 may have a cavity sidewall attachment 310 and a pressing mass attachment 312 at locations on their respective walls that allow the pressing mass 304 to move up and down without substantially stretching the flexible membrane 308. For example, the cavity sidewall attachment 310 is located higher relative to the pressing mass attachment 312 when the pressing mass 304 is positioned in the cavity 302 corresponding to a state in which the energy reservoir 300 is empty of energy medium (in FIG. 3A). When the energy reservoir 300 is substantially filled with fluid 330 as shown in FIG. 3B, the pressing wall attachment 312 is located higher than the cavity sidewall attachment 310. The flexible membrane 308 rolls and unrolls as needed as the energy storage reservoir 300 is filled with fluid 330. The example implementation shown in FIGS. 3A and 3B illustrates the energy storage reservoir 300 as having a fluid reservoir formed by the cavity sidewalls 302a, 302b, the bottom surface of the pressing mass 304, the flexible membrane 308, and the space inside when occupied by the energy fluid medium.

In an example implementation in which the cavity sidewalls 302a, 302b and the pressing mass 304 are made of concrete, the cavity sidewall attachment 310 and the pressing wall attachment 312 may be fixed to the corresponding cavity sidewalls 302a, 302b and pressing mass walls 304a, 304b during the forming of the cavity 302 and the pressing mass 304. For example, a concrete or cement mixture may be poured into a form or mold that shapes the cavity 302, and into a second form that shapes the pressing mass 304. The concrete or cement mixture may be poured into the form for the cavity 302 while the edges of the flexible membrane 308 are sufficiently inserted into the form of the cavity 302 at a desired location on the cavity sidewalls 302a, 302b. Similarly, the concrete or cement mixture may be poured into the form for the pressing mass 304 while the edges of the flexible membrane 308 opposite the edges at the cavity sidewall attachment 310 are sufficiently inserted into the form of the pressing mass 304 at a desired location on the pressing mass walls 304a, 304b. The forms or molds of the cavity 302 and pressing mass 304 may be made of steel, wood, or any other suitable material capable of holding the required amount of cement or concrete mixture. The forms may include a slit or opening permitting insertion of the flexible membrane edges at the desired locations where the edges may be secured as the concrete or cement mixture is poured. Once the mixture hardens around the edges, the flexible membrane 308 may remain secured at the cavity sidewall attachment 310 and the pressing mass wall attachment 312. It is to be understood by those of ordinary skill in the art that the example energy storage reservoir 300 described here with reference to FIGS. 3A, 3B, and 3C are not limited to the attachment of the flexible membrane 308 described. Any suitable form of attaching the flexible membrane 308 to the sidewalls 302a, 302b and to the pressing mass walls 304a, 304b may be used.

Structure may be added to the energy storage reservoir 300 for stabilizing the pressing mass 304 as it moves up and down into and out of the cavity 302. Referring to FIG. 3A, the pressing mass 304 includes a pressing mass vertical support 324 around the perimeter of the pressing mass 304 positioned to extend the surface of the vertical mass walls 304a, 304b. The cavity 302 includes a cavity vertical support 326 extending up from the cavity 302 at the cavity sidewalls 302a, 302b positioned to extend the surface of the cavity sidewalls 302a, 302b. The space between the pressing mass vertical support 324 and the cavity vertical support 326 may be provided with a stabilizing apparatus 340 mounted on either the pressing mass vertical support 324 or on the cavity vertical support 326. If mounted on the pressing mass vertical support 324, the stabilizing apparatus 340 is mounted to be in contact with the cavity vertical support 326. If mounted on the cavity vertical support 326, the stabilizing apparatus 340 is mounted to be in contact with the pressing mass vertical support 324. The stabilizing apparatus 340 may be positioned at selected locations around the pressing mass 304. In addition, the pressing mass vertical support 324 and the cavity vertical support 326 may be structures mounted in locations at which the stabilizing apparatus 340 is mounted, or single structures extending around the perimeter of the pressing mass 304 and cavity 302, respectively. The stabilizing apparatus 340 may be implemented as wheels or rollers and positioned so that the outer surface of the stabilizing apparatus 340 contact the surface of the cavity vertical support 326 as the pressing mass 304 moves up and down. The stabilizing apparatus 340 limits the lateral motion of the pressing mass 304 while guiding the motion of the pressing mass 340 in the vertical direction.

It is noted that the pressing mass vertical support 324 may not be necessary if the pressing mass 304 has a height sufficient to contact the stabilizing apparatus 340 as the pressing mass 304 moves up. Similarly, the cavity sidewall vertical support 326 may not be necessary if the cavity sidewalls 302a, 302b extend to a sufficient height that permits mounting the stabilizing apparatus 340 on the surface of the cavity sidewalls 302a, 302b.

In an example implementation of the energy storage reservoir 300 in FIGS. 3A and 3B, the cavity 302 may measure about 225 meters in diameter and 25 meters deep. The pressing mass 304 may be a rock mass 25 meters thick and weighing about 2.6 billion kilograms. The pressing mass 304 may be sized to leave about a 10 cm space between the cavity sidewalls 302a, 302b. The flexible membrane 308 may be implemented as a flexible film having a tensile stress that is 40% of the tensile strength of a commercially available 0.050 in. thick membrane. If water is used as the energy medium 330, a pressure of about 895 kPa or 130 psi may be exerted on the flexible membrane 308.

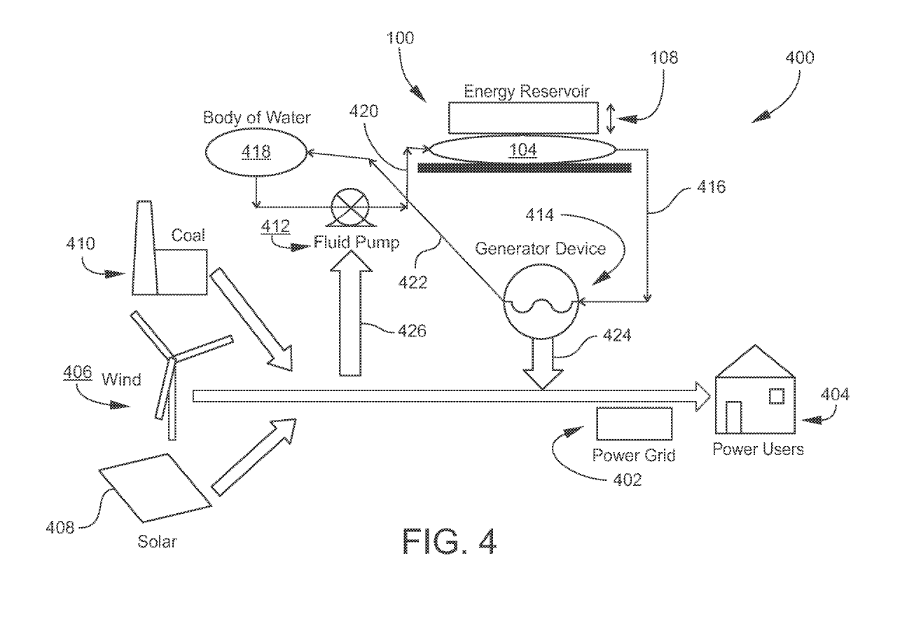

FIG. 4 is a schematic of an energy management system 400 according to the present invention. As shown in FIG. 4, the energy storage reservoir 100 may be used in conjunction with the energy management system 400. It is noted that the energy management system 400 in FIG. 4 may also implement the energy storage reservoir 140 in FIG. 1B, the energy storage reservoir 160 in FIG. 1C, the energy storage reservoir 200 in FIG. 2A, the energy storage reservoir 230 in FIG. 2B, the energy storage reservoir 250 in FIG. 2C, or the energy storage reservoir 300 in FIGS. 3A and 3B. The example energy storage reservoir 100 in FIG. 1A is used with reference to FIG. 4 for purposes of specifying an example in the description.

The energy management system 400 may include the energy storage reservoir 100 and a fluid pump 412 in communication (via fluid path 420) with the fluid reservoir 104. The energy management system 400 may also include a grid-connected generator device 414 configured for generating output power 424 when the fluid is released from the fluid reservoir 104 (via fluid path 416) and into contact with the generator device 414. As illustrated in FIG. 4, the output power 424 from the generator device 414 may be transmitted to the power grid 402, and subsequently transmitted to power users 404.

In implementations in which the fluid includes water that is pumped from a body of water 418 by the fluid pump 412, a reversible pump/turbine/generator may serve as both the grid-connected generator device 414 and as the fluid pump 412 for supplying water to the fluid reservoir 104. The fluid reservoir 104 may use the single opening 128 shown in FIG. 1A with the reversible pump/turbine/generator. In some implementations, the energy management system 400 may include a recycle fluid path 422, such that water may be returned to the body of water 418 after exiting the generator device 414.

The energy management system 400 may include a fluid pump power supply 426 that is generated from any energy source; i.e., the energy storage reservoir 100 may be used to store energy from any energy source. For example, energy may be supplied to the energy management system 400 from an intermittent energy source, such as wind 406 or solar 408. In some implementations, power may be generated from the wind energy 406 or solar energy 408 by a wind turbine or solar cell, respectively, and the power that is generated may be used as the power supply 426 to the fluid pump 412. When the supply of energy to the energy management system 400 is derived from an intermittent energy source, the energy storage reservoir 100 may be used to level the supply of energy to the grid-connected electrical power generator 414. For example, the energy storage reservoir 100 may be used to absorb the energy load at times of high output and low energy demand, thus providing added peak capacity.

In some implementations, energy may be supplied to the energy management system 400 from a continuous energy source, such as energy derived from the burning of coal 410 in a coal-burning power plant. The power that is generated from the burning of coal 410 may be used as the fluid pump power supply 426.

The energy storage reservoir 100 may be used for load balancing; i.e., the energy storage reservoir 100 may be used: (1) to store the energy derived from the burning of coal 410 that is supplied to the energy management system 400 during off-peak times; and (2) to release the stored energy during on-peak times. The energy storage reservoir 100 may be used for other applications for stored energy in the electrical grid besides load balancing. For example, the energy storage reservoir 100 may be used for regulation, or the matching of the faster variations of the electrical load with the electricity generation. When referring to speed, the time scales are understood to be more on the scale of seconds. The variations in electrical load are due to the random nature of loads being turned on and off. Regulation is similar in principle to balancing the load and the generation. Regulation is performed on a much faster time scale. With the use of variable speed pumps and turbines, the energy storage system 100 described here can respond at this faster scale and provide regulation support to the grid.

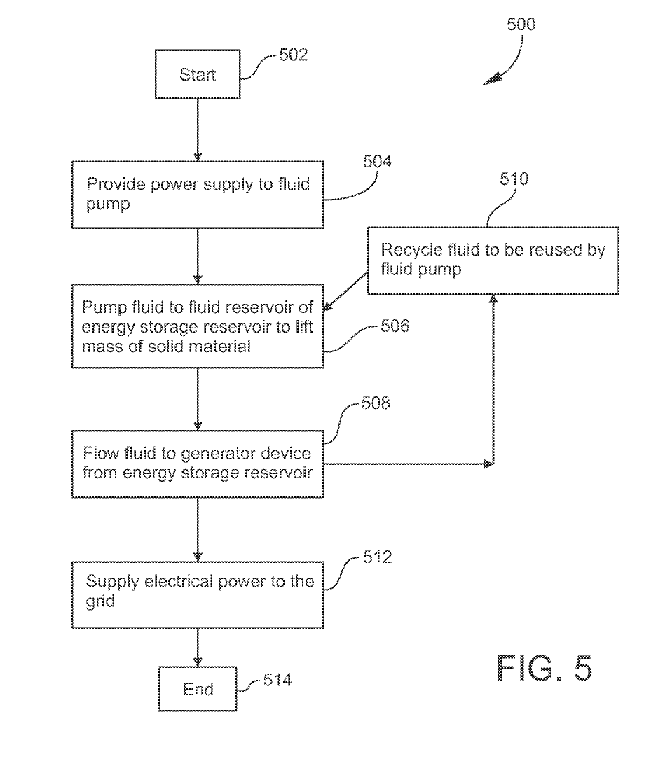

FIG. 5 is a flow chart 500 illustrating an example of a method for managing energy according to the present invention. The flow chart 500 may also represent an apparatus or system capable of performing the illustrated method. The method begins at the starting point 502. Power is supplied to the fluid pump 412 at block 504. The power that is supplied to the fluid pump 412 may be generated from any energy source, such as an intermittent energy source 406 or 408, or a continuous energy source 410. At block 506, fluid is pumped by the fluid pump 412 into the fluid reservoir 104, causing the fluid reservoir 104 to lift the pressing mass 108 or 208 supported by the top surface 112 of the fluid reservoir 104 as the volume within the fluid reservoir 104 increases, thus pressurizing the fluid within the fluid reservoir 104. When there is a demand for the energy stored in the energy reservoir 100 or 200 (e.g., during on-peak times) the fluid that is stored in the fluid reservoir 104 may be released. At block 508, the fluid may be flowed to the generator device 414 to generate electric power. As shown at block 510, after the fluid is used to generate electrical power, the fluid may be recycled to be reused by the fluid pump 412 to charge the fluid reservoir 104. At block 512, the electrical power that is generated at block 508 may be transmitted to the power grid 402. The method ends at the ending point 514.

As noted above, FIG. 4 may represent an example of an apparatus or system 400 for performing the illustrated method. Accordingly, the blocks 504-512 may be considered as depicting one or more means for performing the function or steps corresponding to those blocks 504-512 just described. Examples of systems, apparatus and devices capable of implementing these functions are described above in conjunction with FIGS. 1A-3B.

### Example Embodiments

Example embodiments provided in accordance with the presently disclosed subject matter include, but are not limited to, the following:

1. An energy management system, comprising:
an energy storage reservoir having:
   a fluid reservoir having a top surface, a bottom surface and a flexible member, the fluid reservoir configured to contain varying quantities of a fluid and to isolate the fluid from the ambient environment, the fluid reservoir having at least one opening for filling or for emptying the fluid reservoir; and
   a pressing mass of solid material positioned above the fluid reservoir, the pressing mass having a weight sufficient to press the fluid in the fluid reservoir and empty the fluid reservoir of the fluid when the fluid reservoir opening is open, the pressing mass being further supported by the fluid in the fluid reservoir when the fluid reservoir contains fluid and the fluid reservoir is closed, the flexible member being disposed around the fluid reservoir to seal the fluid and to facilitate vertical motion of the pressing mass as the fluid reservoir is filled and emptied; and
a fluid pump configured to supply fluid to the fluid reservoir via the at least one opening.

2. The energy management system of embodiment 1, where the fluid pump comprises a grid-connectable reversible pump-generator device that is configured for generating output power when the fluid is released from the fluid reservoir and into contact with the reversible pump-generator device.

3. The energy management system of embodiment 1, further comprising a grid-connectable generator device in communication with the fluid reservoir, where the generator device is configured for generating output power when the fluid is released from the fluid reservoir and into contact with the generator device.

4. The energy management system of embodiment 3, where the fluid comprises water that is pumped from a body of water by the fluid pump, the energy management system further comprising a recycle fluid path located downstream from the generator device, where the recycle fluid path is configured for returning water to the body of water after exiting the generator device.

5. The energy management system of embodiment 3, where the generator device is positioned at an elevation that is lower than an elevation of the energy storage reservoir.

6. The energy management system of embodiment 1, where the fluid comprises compressed air.

7. The energy management system of embodiment 1, where the fluid comprises water that is pumped from a body of water by the fluid pump.

8. The energy management system of embodiment 7, where the body of water is located at an elevation that is lower than an elevation of the energy storage reservoir.

9. The energy management system of embodiment 1, further comprising a fluid pump power supply that is generated from an intermittent energy source.

10. The energy management system of embodiment 9, where the intermittent energy source is wind or solar.

11. The energy management system of embodiment 1, further comprising a fluid pump power supply that is generated from a substantially continuous energy source.

12. The energy management system of embodiment 1, where the solid material of the pressing mass is a material selected from the group consisting of rock, sand, dirt, mine tailings, landfill waste, industrial waste, slag and combinations of two or more of the foregoing.

13. The energy management system of embodiment 1 where the solid material of the pressing mass includes a plurality of solid masses.

14. The energy management system of embodiment 1 where the solid material of the pressing mass includes loose material supported in a containment structure.

15. The energy management system of embodiment 1, further comprising a levee positioned about the energy storage reservoir.

16. The energy management system of embodiment 1 where:
the top surface of the fluid reservoir is formed on a first layer in contact with a bottom pressing mass surface;
the bottom surface of the fluid reservoir is formed on a second layer having the opening for filling or emptying the fluid reservoir; and
the flexible member includes a flexible sidewall affixed to the first layer on one end of the flexible sidewalls, and to the second layer on the other end of the flexible sidewalls to enclose the fluid in the fluid reservoir.

17. The energy management system of embodiment 16 where the top surface, the bottom surface and the flexible sidewall are made of the same material.

18. The energy management system of embodiment 16 where:
the top surface and the bottom surface are made of any substantially rigid material; and
the flexible sidewall is made of a flexible material that is different from the top and bottom surface materials.

19. The energy management system of embodiment 18 where:
the top and bottom surface materials are either concrete, metal or combinations thereof.

20. The energy management system of embodiment 18 where:
flexible sidewall material is a polymeric material including chlorosulfonated polyethylene (e.g., Hypalon®), reinforced neoprene (such as Kevlar®-reinforced neoprene), or combinations thereof.

21. The energy management system of embodiment 17 where:
the material of the top and bottom surfaces and of the flexible sidewall is a polymeric material including chlorosulfonated polyethylene (e.g., Hypalon®), reinforced neoprene (such as Kevlar®-reinforced neoprene), or combinations thereof.

22. The energy management system of embodiment 16, where the energy storage reservoir further comprises a substantially rigid platform disposed between the top surface of the fluid reservoir and the mass of solid material.

23. The energy management system of embodiment 22, where the substantially rigid platform comprises a bottom surface in contact with the top surface of the fluid reservoir, where the bottom surface of the substantially rigid platform has a V-shaped cross section.

24. The energy management system of embodiment 23 where bottom surface of the fluid reservoir is set on a matching taper substantially matching the V-shaped cross section of the bottom surface of the substantially rigid platform.

25. The energy management system of embodiment 16, where the fluid reservoir further includes steel mesh covering the exterior surfaces of the flexible sidewalls.

26. The energy management system of embodiment 1, where the fluid reservoir includes a plurality of reservoirs, each reservoir having a top surface, a bottom surface and opposing flexible sidewalls, each reservoir further having a reservoir opening in the bottom surface of the reservoir, where the pressing mass is supported by the top surface of each of the plurality of reservoirs.

27. The energy management system of embodiment 1 further comprising:
a plurality of towers positioned to surround the energy storage reservoir; and
a cable extending from each tower to a corresponding cable connector mounted in the pressing mass, each cable having a connection to a cable pulling apparatus configured to adjust a pulling force applied to the corresponding cable, the cables being controlled to stabilize the pressing mass using the pulling force.

28. The energy management system of embodiment 27 where the pressing mass includes a retaining wall surrounding the solid material, and where the cable connectors are mounted in the retaining wall.

29. The energy management system of embodiment 27 where the pressing mass includes a platform having a surface in contact with the solid material of the pressing mass, and where the cable connectors are mounted in the platform.

30. The energy management system of embodiment 1 further comprising:
a cavity formed by a rigid cavity sidewall of solid material surrounding a space in the cavity, the cavity further having a cavity floor, where the pressing mass includes a pressing mass bottom surface and pressing mass walls extending upward from the pressing mass bottom surface, the pressing mass having a perimeter formed by the pressing mass walls that substantially conforms to the perimeter formed by the cavity sidewall of the cavity, the pressing mass having a size such that the pressing mass moves up and down inside the cavity;
where:
   the flexible member is a flexible membrane extending from a first edge attached to the pressing mass wall and a second edge attached to the cavity sidewall to provide a substantial seal across the space between the pressing mass wall and the cavity sidewall;
   the top surface of the fluid reservoir is the pressing mass bottom surface,
   the bottom surface of the fluid reservoir is the cavity floor, and
   the at least one opening for filling or for emptying the fluid is formed in the cavity floor.

31. The energy management system of embodiment 30 where:
the cavity sidewall extends around the cavity space to form a circle when viewed from overhead.

32. The energy management system of embodiment 30 where:
the cavity sidewall extends around in connecting segments to form a multiple-sided shape when viewed from overhead.

33. The energy management system of embodiment 30 where the flexible membrane attaches to an upper half of the cavity sidewall and a lower half of the pressing wall.

34. The energy management system of embodiment 30 where the pressing mass is made of rock, sand, dirt, mine tailings, landfill waste, industrial waste, slag and combinations of two or more of the foregoing.

35. The energy management system of embodiment 30 where the pressing mass and cavity sidewalls are formed with concrete poured into a form while the edges of the flexible membrane are inserted into the form so that the flexible membrane is maintained secure by the setting of the concrete.

36. The energy management system of embodiment 30 further comprising:

a stabilizing apparatus fixedly mounted in the cavity space at selected positions around the cavity space, the stabilizing apparatus having outer surfaces configured to prevent lateral movement of the pressing mass and to guide movement of the pressing mass in an upward or downward direction.

37. The energy management system of embodiment 36 where the stabilizing apparatus includes either wheels or rollers.

38. The energy management system of embodiment 36 further comprising:

at least one pressing mass vertical support extending upward from the pressing mass at the pressing mass wall to extend the surface of the pressing mass wall in the upward direction at locations corresponding to the selected locations of the stabilizing apparatuses.

39. The energy management system of embodiment 36 further comprising:
at least one cavity vertical support extending from the cavity sidewall to extend the surface of the cavity sidewall in an upward direction at locations corresponding to the selected locations of the stabilizing apparatuses.

40. The energy management system of embodiment 36 where:

the stabilizing apparatus is mounted on the pressing mass wall; and

the outer surface of the stabilizing apparatus is configured to contact the cavity wall surface.

41. The energy management system of embodiment 36 where:

the stabilizing apparatus is mounted on the cavity sidewall; and

the outer surface of the stabilizing apparatus is configured to contact the pressing mass wall surface.

42. The energy management system of embodiment 38 where:
the stabilizing apparatus is mounted on the pressing mass vertical support; and
the outer surface of the stabilizing apparatus is configured to contact the cavity sidewall surface.

43. The energy management system of embodiment 39 where:
the stabilizing apparatus is mounted on the cavity vertical support; and
the outer surface of the stabilizing apparatus is configured to contact the pressing mass wall surface.

44. The energy management system of embodiment 30 where the cavity is formed in a structure extending upward from the earth such that at least a portion of the structure extends above a surrounding grade level.

45. The energy management system of embodiment 30 where the cavity is formed in a structure in the earth such that a majority of the structure extends below a surrounding grade level.

46. The energy management system of embodiment 30 where the cavity sidewall is substantially vertical.

47. The energy management system of embodiment 30 where the cavity sidewall is substantially a concave curve.

48. The energy management system of embodiment 30 where the cavity sidewall is substantially straight and slanted out from the cavity bottom surface.

49. A method for managing energy in an energy storage reservoir, the method comprising:
pumping a fluid into an opening of a fluid reservoir, the fluid reservoir having a top surface, a bottom surface and a flexible member disposed around the fluid reservoir to seal the fluid and to facilitate vertical motion of a pressing mass of solid material positioned on top of the fluid reservoir, the pressing mass being lifted as the fluid fills the fluid reservoir;
stopping the opening to stop the fluid flow into the fluid reservoir and holding the fluid in the fluid reservoir;
opening the fluid reservoir to release the fluid; and
pushing the fluid out of the fluid reservoir by a downward force of the pressing mass to provide a flow of fluid for generating energy.

50. The method of embodiment 49, further comprising generating electrical power by driving a grid-connected generator device using the flow of the fluid from the energy storage reservoir.

51. The method of embodiment 50, further comprising generating the electrical power during peak demand by performing the step of opening the fluid reservoir at a time corresponding to the peak demand.

52. The method of embodiment 50, where the step of pumping the fluid includes pumping water from a body of water by using a fluid pump, the method further comprising recycling the water to the water body after generating the electrical power by directing a flow of water used to generate energy back to the body of water.

53. The method of embodiment 49, further comprising supplying power that is generated from an intermittent energy source to a fluid pump used in the step of pumping the fluid.

54. The method of embodiment 53, where the intermittent energy source is wind or solar.

55. The method of embodiment 53, further comprising supplying power to the fluid pump that is generated from a substantially continuous energy source.

56. The method of embodiment 53, further comprising supplying power to the fluid pump that is generated during off-peak demand.

57. The method of embodiment 49, further comprising providing the fluid reservoir by:
forming the top surface of the fluid reservoir on a first layer in contact with a bottom pressing mass surface;
forming the bottom surface of the fluid reservoir on a second layer having the opening for filling or emptying the fluid reservoir; and
forming the flexible member as a flexible sidewall affixed to the first layer on one end of the flexible sidewall, and to the second layer on the other end of the flexible sidewall to enclose the fluid in the fluid reservoir, the flexible sidewall being sufficiently flexible to adapt in shape to a changing volume of fluid in the fluid reservoir, and the top surface disposed to support the pressing mass.

58. The method of embodiment 57, further comprising providing a substantially rigid platform between the fluid reservoir and the pressing mass of solid material, the platform comprising a bottom surface in contact with the top surface of the fluid reservoir and a top surface in contact with the pressing mass of solid material.

59. The method of embodiment 58 further comprising providing the substantially rigid platform having a bottom surface with a V-shaped cross section pressing on the fluid reservoir.

60. The method of embodiment 59 further comprising providing a ground surface supporting the fluid reservoir with a V-shaped cross section to match the bottom surface of the rigid platform.

61. The method of embodiment 57 further providing a steel mesh disposed on the exterior surface of the flexible sidewall of the fluid reservoir.

62. The method of embodiment 49, further comprising providing the fluid reservoir as a plurality of reservoirs each having at least one opening for pumping fluid into and out of the reservoirs, where each reservoir has a top surface, a bottom surface, and a flexible sidewall, where the pressing mass of solid material is further supported by the top surfaces of the plurality of reservoirs.

63. The method of embodiment 50 where:
the step of pumping the fluid includes pumping the fluid using a grid-connectable reversible pump-generator device when filling the fluid reservoir; and
the step of generating the electric power includes using the reversible pump-generator device as the grid-connected generator device to generate the power from the flow of the fluid from the energy storage reservoir.

64. The method of embodiment 50 further comprising positioning the grid-connected generator device at a lower elevation than the energy storage reservoir.

65. The method of embodiment 49 where the step of pumping the fluid includes pumping air as the fluid.

66. The method of embodiment 49 where the step of pumping the fluid includes pumping water as the fluid from a body of water.

67. The method of embodiment 66 further comprising pumping the water from a body of water that is at a lower elevation than the energy storage reservoir.

68. The method of embodiment 49 further comprising providing the pressing material by selecting the solid material from a group consisting of rock, sand, dirt, mine tailings, landfill waste, industrial waste, slag and combinations of two or more of the foregoing.

69. The method of embodiment 49 further comprising providing the pressing material as a plurality of solid masses.

70. The method of embodiment 49 further comprising providing the pressing material as loose material supported by a containment structure.

71. The method of embodiment 49 further comprising:
providing a plurality of towers around the fluid reservoir, each tower having a cable extending from the tower to a corresponding cable connector mounted on the containment structure of the pressing mass; and
stabilizing the pressing mass by adjusting the tension on the cable between the tower and the cable connectors.

72. The method of embodiment 49 further comprising:
providing a plurality of towers around the fluid reservoir, each tower having a cable extending from the tower to a corresponding cable connector mounted on a platform disposed between the pressing mass and the fluid reservoir; and
stabilizing the pressing mass by adjusting the tension on the cable between the tower and the cable connectors.

73. The method of embodiment 49 further comprising:
providing a cavity having a solid cavity sidewall and a cavity bottom with an opening for pumping fluid in the cavity bottom;
providing a pressing mass of solid material having a pressing mass wall and a pressing mass bottom surface in the cavity, where a space is formed around the pressing mass between the pressing mass wall and the cavity sidewall;
providing the flexible member as a flexible membrane fixed at a first edge to the pressing mass wall and at a second edge to the cavity sidewall to form a substantial seal across the space between the pressing mass wall and the cavity sidewall, where the fluid reservoir is formed by the pressing mass bottom surface, the flexible membrane, the opposing cavity sidewall, and the cavity bottom surface.

74. The method of embodiment 73 where the step of providing the cavity includes forming the cavity sidewall to extend around the cavity space to form a circle when viewed from overhead.

75. The method of embodiment 73 where the step of providing the cavity includes forming the cavity sidewall to extend around in connecting segments to form a multiple-sided shape when viewed from overhead.

76. The method of embodiment 73 where the step of providing the flexible membrane includes attaching the first edge to a lower half of the pressing wall and attaching the second edge to an upper half of the cavity sidewall.

77. The method of embodiment 73 further comprising:
forming the pressing mass and cavity sidewalls with concrete poured into a form while the edges of the flexible membrane are inserted into the form so that the flexible membrane is maintained secure by the setting of the concrete.

78. The method of embodiment 73 further comprising:
mounting a stabilizing apparatus into the cavity space at selected positions around the cavity space; and
stabilizing the pressing mass by preventing lateral movement and guiding movement of the pressing mass in an upward or downward direction.

79. The method of embodiment 78 where the step of mounting the stabilizing apparatus includes the step of using either wheels or rollers on the stabilizing apparatus.

80. The method of embodiment 78 where the step of stabilizing the pressing mass includes:
providing contact between the stabilizing apparatus and the pressing mass wall.

81. The method of embodiment 78 where the step of stabilizing the pressing mass includes:
providing contact between the stabilizing apparatus and the cavity sidewall.

82. The method of embodiment 78 further comprising:
providing contact between the stabilizing apparatus and the pressing mass wall.

83. The method of embodiment 78 further comprising:
extending at least one pressing mass vertical support upward from the pressing mass at the pressing mass wall to extend the surface of the pressing mass wall in the upward direction.

84. The method of embodiment 83 where the step of stabilizing the pressing mass includes:
mounting the stabilizing apparatus on the pressing mass vertical support; and
providing contact between the stabilizing apparatus and the cavity sidewall as the pressing mass moves up or down.

85. The method of embodiment 78 further comprising:
extending at least one cavity vertical support upward from the cavity sidewall to extend the surface of the cavity sidewall in the upward direction.

86. The method of embodiment 85 where the step of stabilizing the pressing mass includes:
mounting the stabilizing apparatus on the cavity vertical support; and
providing contact between the pressing mass vertical support and the stabilizing apparatus as the pressing mass moves up or down.

87. The method of embodiment 73 further comprising the step of:
forming the cavity in a structure extending upward from the earth such that at least a portion of the structure extends above a surrounding grade level.

88. The method of embodiment 73 further comprising the step of:
forming the cavity in a structure in the earth such that a majority of the structure extends below a surrounding grade level.

89. The method of embodiment 73 further comprising the step of:
forming the cavity sidewall to be substantially vertical.

90. The method of embodiment 73 further comprising the step of forming the cavity sidewall to be substantially a concave curve.

91. The method of embodiment 73 further comprising the step of forming the cavity sidewall to be substantially straight and slanted out from the cavity bottom surface.

92. An energy storage reservoir for use in an energy management system, the energy storage reservoir comprising:
a fluid reservoir having a top surface, a bottom surface and a flexible member, the fluid reservoir configured to contain varying quantities of a fluid and to isolate the fluid from the ambient environment, the fluid reservoir having at least one opening for filling or for emptying the fluid reservoir; and
a pressing mass of solid material positioned above the fluid reservoir, the pressing mass having a weight sufficient to press the fluid reservoir and empty the fluid reservoir of the fluid when the fluid reservoir opening is open, the pressing mass being further supported by the fluid reservoir when the fluid reservoir contains fluid and the fluid reservoir is closed, the flexible member being disposed around the fluid reservoir to seal the fluid and to facilitate vertical motion of the pressing mass as the fluid reservoir is filled and emptied.

93. The energy storage reservoir of embodiment 92, where the solid material of the pressing mass is a material selected from the group consisting of rock, sand, dirt, mine tailings, landfill waste, industrial waste, slag and combinations of two or more of the foregoing.

94. The energy storage reservoir of embodiment 92, where the solid material of the pressing mass includes a plurality of solid masses.

95. The energy storage reservoir of embodiment 92, where the solid material of the pressing mass includes loose material supported in a containment structure.

96. The energy storage reservoir of embodiment 92 where:
the top surface of the fluid reservoir is formed on a first layer in contact with a bottom pressing mass surface;
the bottom surface of the fluid reservoir is formed on a second layer having the opening for filling or emptying the fluid reservoir; and
the flexible member includes a flexible sidewall affixed to the first layer on one end of the flexible sidewalls, and to the second layer on the other end of the flexible sidewalls to enclose the fluid in the fluid reservoir.

97. The energy storage reservoir of embodiment 96 where the top surface, the bottom surface and the flexible sidewall are made of the same material.

98. The energy storage reservoir of embodiment 96 where:

the top surface and the bottom surface are made of any substantially rigid material; and

the flexible sidewall is made of a flexible material that is different from the top and bottom surface materials.

99. The energy storage reservoir of embodiment 98 where:

the top and bottom surface materials are either concrete, metal or combinations thereof.

100. The energy storage reservoir of embodiment 98 where:

flexible sidewall material is a polymeric material including chlorosulfonated polyethylene (e.g., Hypalon®), reinforced neoprene (such as Kevlar®-reinforced neoprene), or combinations thereof.

101. The energy storage reservoir of embodiment 97 where:

the material of the top and bottom surfaces and of the flexible sidewall is a polymeric material including chlorosulfonated polyethylene (e.g., Hypalon®), reinforced neoprene (such as Kevlar®-reinforced neoprene), or combinations thereof.

102. The energy storage reservoir of embodiment 92 further comprising a substantially rigid platform disposed between the top surface of the fluid reservoir and the mass of solid material.

103. The energy storage reservoir of embodiment 96, where the substantially rigid platform comprises a bottom surface in contact with the top surface of the fluid reservoir, where the bottom surface of the substantially rigid platform has a V-shaped cross section.

104. The energy storage reservoir of embodiment 103 further comprising a matching taper in a ground supporting the fluid reservoir, the matching taper substantially matching the V-shaped cross section of the bottom surface of the substantially rigid platform.

105. The energy storage reservoir of embodiment 96 further comprising a steel mesh disposed on the exterior surfaces of the flexible sidewall.

106. The energy storage reservoir of embodiment 92, where the fluid reservoir includes a plurality of reservoirs, each reservoir having a top surface, a bottom surface and flexible sidewall, each reservoir further having a reservoir opening in the bottom surface of the reservoir, where the pressing mass is supported by the top surface of each of the plurality of reservoirs.

107. The energy storage reservoir of embodiment 92 further comprising:
a plurality of towers positioned to surround the energy storage reservoir; and
a cable extending from each tower to a corresponding cable connector mounted in the pressing mass, each cable having a connection to a cable pulling apparatus configured to adjust a pulling force applied to the corresponding cable, the cables being controlled to stabilize the pressing mass using the pulling force.

108. The energy storage reservoir of embodiment 107 where the pressing mass includes a retaining wall surrounding the solid material, and where the cable connectors are mounted in the retaining wall.

109. The energy storage reservoir of embodiment 107 where the pressing mass includes a platform having a surface in contact with the solid material of the pressing mass, and where the cable connectors are mounted in the platform.

110. The energy storage reservoir of embodiment 92 further comprising:
a cavity formed by a rigid cavity sidewall of solid material surrounding a space in the cavity, the cavity further having a cavity floor, where the pressing mass includes a pressing mass bottom surface and pressing mass walls extending upward from the pressing mass bottom surface, the pressing mass having a perimeter formed by the pressing mass walls that substantially conforms to the perimeter formed by the cavity sidewall of the cavity, the pressing mass having a size such that the pressing mass moves up and down inside the cavity;
where:
   the flexible member is a flexible membrane extending from a first edge attached to the pressing mass wall and a second edge attached to the cavity sidewall to provide a substantial seal across the space between the pressing mass wall and the cavity sidewall;
   the top surface of the fluid reservoir is the pressing mass bottom surface,
   the bottom surface of the fluid reservoir is the cavity floor, and
   the at least one opening for filling or for emptying the fluid is formed in the cavity floor.

111. The energy storage reservoir of embodiment 110 where:
the cavity sidewall extends around the cavity space to form a circle when viewed from overhead.

112. The energy storage reservoir of embodiment 110 where:
the cavity sidewall extends around in connecting segments to form a multiple-sided shape when viewed from overhead.

113. The energy storage reservoir of embodiment 110 where the flexible membrane attaches to an upper half of the cavity sidewall and a lower half of the pressing wall.

114. The energy storage reservoir of embodiment 110 where the pressing mass is made of rock, sand, dirt, mine tailings, landfill waste, industrial waste, slag and combinations of two or more of the foregoing thereof.

115. The energy storage reservoir of embodiment 110 where the pressing mass and cavity sidewalls are formed with concrete poured into a form while the edges of the flexible membrane are inserted into the form so that the flexible membrane is maintained secure by the setting of the concrete.

116. The energy storage reservoir of embodiment 110 further comprising:
a stabilizing apparatus fixedly mounted in the cavity space at selected positions around the cavity space, the stabilizing apparatus having outer surfaces configured to prevent lateral movement of the pressing mass and to guide movement of the pressing mass in an upward or downward direction.

117. The energy storage reservoir of embodiment 116 where the stabilizing apparatus includes either wheels or rollers.

118. The energy storage reservoir of embodiment 116 further comprising:

at least one pressing mass vertical support extending upward from the pressing mass at the pressing mass wall to extend the surface of the pressing mass wall in the upward direction at locations corresponding to the selected locations of the stabilizing apparatuses.

119. The energy storage reservoir of embodiment 116 further comprising:
at least one cavity vertical support extending from the cavity sidewall to extend the surface of the cavity sidewall in an upward direction.

120. The energy storage reservoir of embodiment 116 where:
the stabilizing apparatus is mounted on the pressing mass wall; and
the outer surface of the stabilizing apparatus is configured to contact the cavity wall surface.

121. The energy storage reservoir of embodiment 116 where:

the stabilizing apparatus is mounted on the cavity sidewall; and

the outer surface of the stabilizing apparatus is configured to contact the pressing mass wall surface.

122. The energy storage reservoir of embodiment 118 where:

the stabilizing apparatus is mounted on the pressing mass vertical support; and

the outer surface of the stabilizing apparatus is configured to contact the cavity sidewall surface.

123. The energy storage reservoir of embodiment 119 where:

the stabilizing apparatus is mounted on the cavity vertical support; and

the outer surface of the stabilizing apparatus is configured to contact the pressing mass wall surface.

124. The energy storage reservoir of embodiment 110 where the cavity is formed in a structure extending upward from the earth such that at least a portion of the structure extends above a surrounding grade level.

125. The energy storage reservoir of embodiment 110 where the cavity is formed in a structure in the earth such that a majority of the structure extends below a surrounding grade level.

126. The energy storage reservoir of embodiment 110 where the cavity sidewall is substantially vertical.

127. The energy storage reservoir of embodiment 110 where the cavity sidewall is substantially a concave curve.

128. The energy storage reservoir of embodiment 110 where the cavity sidewall is substantially straight and slanted out from the cavity bottom surface.

For purposes of the present disclosure, it will be understood that terms such as “formed on” or “disposed on” or “supported by” are not intended to introduce any limitations relating to particular methods of material transport, deposition, fabrication, surface treatment, or physical, chemical, or ionic bonding or interaction. The term “interposed” is interpreted in a similar manner.

In general, terms such as “communicate” and “in . . . communication with” (for example, a first component “communicates with” or “is in communication with” a second component) are used herein to indicate a structural, functional, mechanical, electrical, signal, optical, magnetic, electromagnetic, ionic or fluidic relationship between two or more components or elements. As such, the fact that one component is said to communicate with a second component is not intended to exclude the possibility that additional components may be present between, and/or operatively associated or engaged with, the first and second components.

It will be understood that various aspects or details of the invention may be changed without departing from the scope of the invention. Furthermore, the foregoing description is for the purpose of illustration only, and not for the purpose of limitation—the invention being defined by the claims.

What is claimed is:

1. An energy management system, comprising:
an energy storage reservoir comprising:
a fluid reservoir comprising a top surface, a bottom surface and a flexible member, the fluid reservoir configured to contain varying quantities of a fluid and to isolate the fluid from the ambient environment, the fluid reservoir comprising at least one opening for filling or for emptying the fluid reservoir; and
a pressing mass of solid material positioned above the fluid reservoir, the pressing mass having a weight sufficient to press the fluid in the fluid reservoir and empty the fluid reservoir of the fluid when the fluid reservoir opening is open, the pressing mass being further supported by the fluid in the fluid reservoir when the fluid reservoir contains fluid and the fluid reservoir is closed, the flexible member being disposed around the fluid reservoir to seal the fluid and to facilitate vertical motion of the pressing mass as the fluid reservoir is filled and emptied; and
a fluid pump configured to supply fluid to the fluid reservoir via the at least one opening.

2. The energy management system of claim 1, further comprising a grid-connectable generator device in communication with the fluid reservoir, wherein the generator device is configured for generating output power when the fluid is released from the fluid reservoir and into contact with the generator device.

3. The energy management system of claim 1, wherein the fluid comprises compressed air.

4. The energy management system of claim 1, wherein the fluid comprises water that is pumped from a body of water by the fluid pump.

5. The energy management system of claim 1, wherein the solid material of the pressing mass is a material selected from the group consisting of rock, sand, dirt, mine tailings, landfill waste, industrial waste, slag and combinations of two or more of the foregoing.

6. The energy management system of claim 1 wherein the solid material of the pressing mass includes a plurality of solid masses.

7. The energy management system of claim 1 wherein the solid material of the pressing mass includes loose material supported in a containment structure.

8. The energy management system of claim 1, further comprising a levee positioned about the energy storage reservoir.

9. The energy management system of claim 1 wherein:
the top surface of the fluid reservoir is formed on a first layer in contact with a bottom pressing mass surface;
the bottom surface of the fluid reservoir is formed on a second layer comprising the opening for filling or emptying the fluid reservoir; and
the flexible member includes a flexible sidewall affixed to the first layer on one end of the flexible sidewalls, and to the second layer on the other end of the flexible sidewalls to enclose the fluid in the fluid reservoir.

10. The energy management system of claim 9, wherein the energy storage reservoir further comprises a substantially rigid platform disposed between the top surface of the fluid reservoir and the mass of solid material.

11. The energy management system of claim 10, wherein the substantially rigid platform comprises a bottom surface in contact with the top surface of the fluid reservoir, wherein the bottom surface of the substantially rigid platform comprises a V-shaped cross section.

12. The energy management system of claim 9, wherein the fluid reservoir further includes steel mesh covering the exterior surfaces of the opposing flexible sidewalls.

13. The energy management system of claim 1, wherein the fluid reservoir includes a plurality of reservoirs, each reservoir comprising a top surface, a bottom surface and opposing flexible sidewalls, each reservoir further comprising a reservoir opening in the bottom surface of the reservoir, wherein the pressing mass is supported by the top surface of each of the plurality of reservoirs.

14. The energy management system of claim 1 further comprising:
a plurality of towers positioned to surround the energy storage reservoir; and
a cable extending from each tower to a corresponding cable connector mounted in the pressing mass, each cable comprising a connection to a cable pulling apparatus configured to adjust a pulling force applied to the corresponding cable, the cables being controlled to stabilize the pressing mass using the pulling force.

15. The energy management system of claim 14 wherein the pressing mass includes a retaining wall surrounding the solid material, and wherein the cable connectors are mounted in the retaining wall.

16. The energy management system of claim 1 further comprising:
a cavity formed by a rigid cavity sidewall of solid material surrounding a space in the cavity, the cavity further comprising a cavity floor, wherein the pressing mass includes a pressing mass bottom surface and pressing mass walls extending upward from the pressing mass bottom surface, the pressing mass having a perimeter formed by the pressing mass walls that substantially conforms to the perimeter formed by the cavity sidewall of the cavity, the pressing mass having a size such that the pressing mass moves up and down inside the cavity;
wherein:
the flexible member is a flexible membrane extending from a first edge attached to the pressing mass wall and a second edge attached to the cavity sidewall to provide a substantial seal across the space between the pressing mass wall and the cavity sidewall;
the top surface of the fluid reservoir is the pressing mass bottom surface,
the bottom surface of the fluid reservoir is the cavity floor, and
the at least one opening for filling or for emptying the fluid is formed in the cavity floor.

17. The energy management system of claim 16 wherein the pressing mass and cavity sidewalls are formed with concrete poured into a form while the edges of the flexible membrane are inserted into the form so that the flexible membrane is maintained secure by the setting of the concrete.

18. The energy management system of claim 16 further comprising:
a stabilizing apparatus fixedly mounted in the cavity space at selected positions around the cavity space, the stabilizing apparatus comprising outer surfaces configured to prevent lateral movement of the pressing mass and to guide movement of the pressing mass in an upward or downward direction.

19. The energy management system of claim 18 wherein the stabilizing apparatus includes either wheels or rollers.

20. The energy management system of claim 18 further comprising:
at least one pressing mass vertical support extending upward from the pressing mass at the pressing mass wall to extend the surface of the pressing mass wall in the upward direction at locations corresponding to the selected locations of the stabilizing apparatuses.

21. The energy management system of claim 18 further comprising:
at least one cavity vertical support extending from the cavity sidewall to extend the surface of the cavity sidewall in an upward direction at locations corresponding to the selected locations of the stabilizing apparatuses.
